(19) United States
(12) Patent Application Publication
(10) Pub. No.: US 2002/0037130 A1
(43) Pub. Date: Mar. 28, 2002

(54) Microfluidic optical switch

(75) Inventors: Sterling Eduard McBride, Princeton, NJ (US); Peter John Zanzucchi, Princeton Junction, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 09/925,885

(22) Filed: Aug. 3, 2001

Related U.S. Application Data
(60) Provisional application No. 60/222,696, filed on Aug. 2, 2000.

(51) Int. Cl. G02B 6/35

(52) U.S. Cl. 385/16

(57) ABSTRACT

An optical switch comprising a fluid contained within a reservoir having a characteristic, a plurality of waveguides are located proximate to the fluid and an actuator is coupled to the fluid for changing the characteristic of the fluid to switch a light signal from one waveguide to another waveguide.

### CROSS-REFERENCE TO RELATED APPLICATIONS

This application claims benefit of U.S. Provisional Patent Application Ser. No. 60/222,696 entitled “Microfluidic Optical Switching Platform” filed Aug. 2, 2000 by McBride and Zanzucchi, and is hereby incorporated by reference in its entirety.

### BACKGROUND OF THE INVENTION

1. Field of the Invention

The present invention relates to an apparatus for switching or redirecting optical signals. More particularly, this invention relates to a microfluidic optical switch.

While signals within telecommunications and data communications networks have been traditionally exchanged by transmitting electric signals via electrically conductive lines, an alternative medium of data exchanged is the transmission of optical signals through optical fibers. To effectively route optical signals through a fiber optic network, optical switches are used. Optical switches are generally fabricated of crystalline materials such as silicon. Small silicon mirrors have been fabricated and activated by an electric field to facilitate switching. Crystalline materials can be fragile and be susceptible to environmental changes. Consequently, there is a need in the art for alternative forms of optical switches.

### SUMMARY OF THE INVENTION

The present invention provides a microfluidic optical switch in which an optical signal is switched without conversion to electrical form. The microfluidic optical switch comprises an input waveguide or fiber, one or more output waveguides or fibers, a fluid filled reservoir and an actuator for changing a characteristic of the fluid in the reservoir. The reservoir is located proximate the ends of the waveguides or fibers. The input waveguide or fiber supplies light to the fluid in the reservoir. The actuator changes a characteristic of the fluid to alter a path of the light. By altering the fluid characteristic, the light is selectively switched into one or more of the output optical waveguides. The fluid characteristics that are controlled to facilitate switching are a fluid/fluid or air/fluid interface (meniscus), a refractive index gradient, and the like.

### BRIEF DESCRIPTION OF THE DRAWINGS

The teachings of the present invention can be readily understood by considering the following detailed description in conjunction with the accompanying drawings, in which:

FIG. 1 is a schematic cross-section view illustrating an optical switch according to the present invention;

FIG. 2 is a schematic view of a second embodiment of an optical switch of the present invention;

FIG. 3 is a schematic cross-section of an electrohydrodynamic actuator;

FIG. 4 is a schematic view of an array of deformable fluid/air interfaces in accordance with the present invention;

FIG. 5 is a schematic cross-section taken of an electrohydrodynamic actuator in accordance with the present invention;

FIG. 6 is a graph of the reflection coefficient as a function of angle of incidence;

FIG. 7 is a schematic view illustrating another embodiment of the present invention;

FIG. 8 is a schematic view illustrating another embodiment of the present invention; and

FIG. 9 is a schematic view illustrating yet another embodiment of the present invention.

To facilitate understanding, identical reference numerals have been used, where possible, to designate identical elements that are common to the figures.

### DETAILED DESCRIPTION

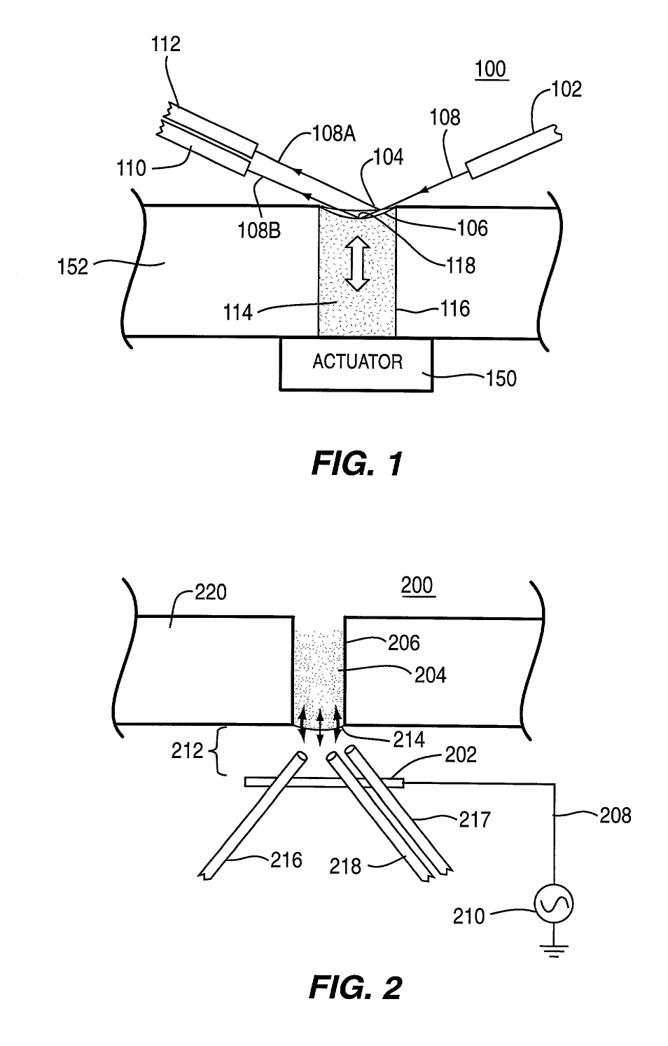

FIG. 1 depicts an embodiment of an optical switch 100 of the present invention. This optical switch 100 uses a characteristic of a fluid to facilitate switching of an optical signal. In this embodiment, an optical waveguide 102 transmits light to a deformable fluid/air interface 118 that deforms to reflect or refract the light 108 into one of a plurality of optical waveguides 110, 112. A fluid/fluid interface may also be used such as the interface between two immiscible fluids. An example would be a water/oil interface. The deformable fluid/air interface 118 is controlled by an actuator 150 and uses, in a particular embodiment, electrohydrodynamic forces to control the fluid/air interface 118.

More specifically, FIG. 1 depicts an optical switch 100 comprising an input optical waveguide or fiber 102, a fluid filled reservoir (for example, a capillary tubule 116), one or more output optical waveguides or fibers 110, 112 and an actuator 150. The input optical waveguide or fiber 102 transmits a beam of light 108 to the fluid 114 contained within the capillary tubule 116. After the light 108 makes contact with the fluid 114, it may be reflected into one of the optical output waveguides 112 or 110. The position of the fluid 114 within the capillary tubule 116 can be controlled by the actuator 150 to create the deformable fluid/air interface 118. The interface 118 can assume a plurality of positions. Two positions 104 or 106 are illustrated.

In practice, if a beam of light 108 transmitted by the optical input waveguide 102 strikes the fluid 114 while the deformable fluid/air interface 118 is in the position 106, the light will be reflected along line 108B into optical output waveguide 110. However, if the light beam 108 is transmitted by optical input waveguide 102 to fluid 114 while the deformable fluid/air interface 118 is in position 104, the light will travel along line 108A into output optical waveguide 112.

The forces produced by the actuator 150 that cause the liquid 114 to move up and down or back and forth in capillary tubule 116 are electrohydrodynamic forces. Without being bound by any particular theory, possible theoretical considerations in electro-based actuators or pumps are set forth in detail in U.S. application Ser. No. 08/556,423, Nov. 9,1995 (“Electrokinetic Pumping”). At least two types of such electro-based pumping have been described, typically under the names “electrohydrodynamic pumping” (EHD) and “electroosmosis” (EO). EHD pumping has been described by Bart, et al., “Microfabricated Electrohydrodynamic Pumps”, Sensors and Actuators, A29:159-168, 1991. EO pumps have been described by Dasgupta, et al., “Electroosmosis: A Reliable Fluid Propulsion System for Flow Injection Analysis”, Anal. Chem., 66:1792-1798,1994.

Several theoretical concepts are believed to play a roll in the mechanics of EHD pumping. The forces acting on a dielectric fluid are believed to be described by:

$$\vec{F} = q \vec{E} + \vec{P} \cdot ∇ \vec{E} - 1 / 2 {E}^{2} ∇ ϵ + ∇ [ 1 / 2 ρ \frac{\partial ϵ}{\partial ρ} {E}^{2} ]$$

where F is the force density, q is the charge density, E is the applied field, P is the polarization vector, ε is the permittivity and ρ is the mass density. Of the terms in the equation, the first and third are believed to be the most significant in the context of EHD pumping of fluids. The first term (qE) relates to the Coulomb interaction with a space-charge region. The third term (½E²∇e) relates to the dielectric force, which is proportional to the gradient in permittivity.

As the fluid/air interface 118 is moved, the point of reflection changes to channel light to any one of the plurality of optical output waveguides 110 and 112. The waveguides 110 and 112 represent any number of a plurality of waveguides that could be used. The interface 118 is commonly referred to as a meniscus. The meniscus forms a concavo-convex lens. The term meniscus may be used in place of fluid/air or fluid/fluid interface through the rest of this specification.

In one embodiment, the optical switch 100 is formed in SiO₂ or a silicon based substrate 152. The ability to form optical waveguides and capillary tubules, channels, or reservoirs in SiO₂ or silicon substrates is well-known in the art.

Although a single fluid may be used, the fluid 114 may be a composite of two immiscible fluids, one fluid having a reflective features while the other fluid acts as a transport plug that may be moved by an electrohydrodynamic actuator 150. Fluids with a reflective feature such as aqueous based solutions, mercury, organic solvents, refractive index matching fluids, hydrocarbons and silicones may be used as the reflecting fluid. The following solvents are non-limiting examples of liquids useful to form the transmission plug used to move the reflective fluid. The immiscible fluid may be, but is not limited to, toluene, methylene, chloride, diethylether, chloroform, benzene, hexane, heptane and octane.

In another embodiment, the interface between two immiscible fluids can be used as the reflective feature.

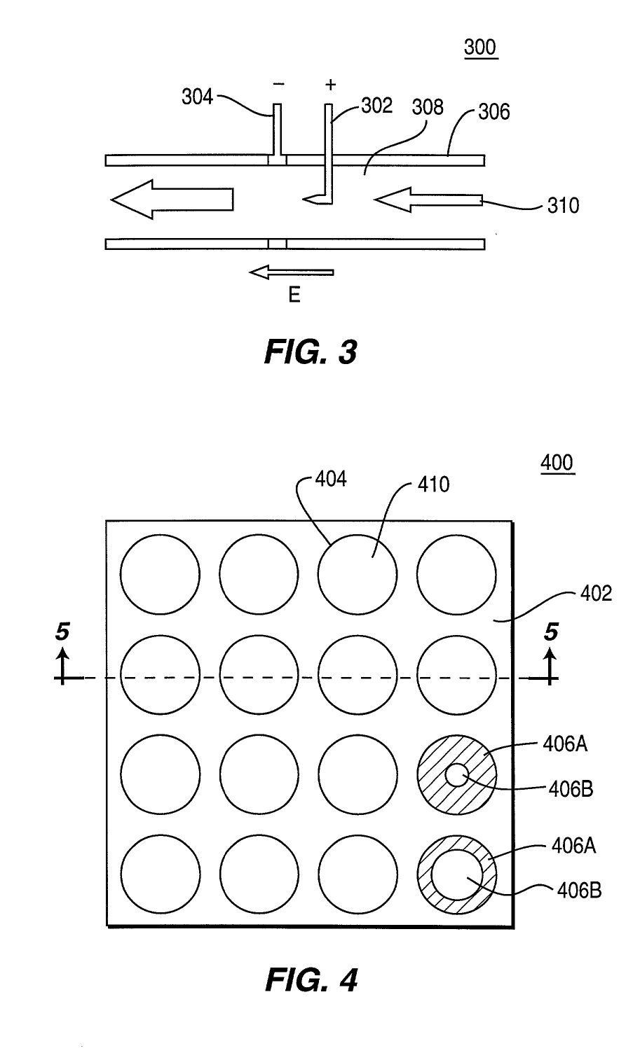

FIG. 3 is a schematic cross-section of an example of an electrohydrodynamic actuator 300 that can be used to position the fluid in the switch of FIG. 1. A point electrode 302 delivers a positive charge to the center of the capillary tube 306 while a negatively charged ring electrode 304 is integrated into the perimeter of the capillary tube 306. The tube 306 may be coupled to the tubule 116 or the tube 306 and tubule 116 may be one in the same. When a voltage is applied to the electrodes both positive 302 and negative 304, an electrohydrodynamic effect is created causing fluid 308 inside the tube 306 to move in the direction as shown by arrows 310 for certain types of fluids. It should be noted that while the present invention can be used to move a wide range of fluids, it is preferred that it move liquids.

The electrodes as shown 304 and 302 may be electrically coupled to driving circuits such as those set forth in U.S. application Ser. No. 08/469,238, Jun. 6,1995 (“Electrokinetic Pumping”) and U.S. application Ser. No. 08/556,423, Nov. 9,1995 (“Electrokinetic Pumping”).

FIG. 2 is a schematic view illustrating another embodiment of an optical switch 200 comprising a fluid filled reservoir (tubule 206) and an electrode 202 positioned proximate a meniscus 214 of the fluid 204. More specifically, the electrode is a planar conductive element that is spaced apart from and parallel to the meniscus 214.

To move the meniscus 214, a dielectric force is generated by applying a voltage to the electrode 202 positioned in front of the fluid/air interface (meniscus) 214. The electrode 202 is not in direct contact with the fluid 204. The electrode 202 is positioned a distance away from the fluid 204 such that a gap 212 is created between the electrode 202 and the meniscus 214. The fluid 204 is held in a capillary tubule 206 by capillary force. A plurality of waveguides 216, 217 and 218 are disposed proximate to the fluid/air interface 214. Waveguide 216 supplies light to the interface 214. The light is reflected into either waveguide 217 or 218 depending upon the position of the interface 214.

The electrode 202 is electrically connected to a voltage source 210 via electrical connection 208. In response to the applied voltage, the meniscus or fluid/air interface 214 reciprocates in a linear fashion reducing or increasing the gap 212 between the fluid 204 and the electrode 202. The electrode 202 coupled to the voltage source 210 creates the electrohydrodynamic force that causes the fluid 204 to change the shape of the meniscus 214. When a voltage is applied to the electrode 214, the meniscus is altered by a force that is created at the interface due to a discontinuity in the dielectric constant. The force is proportional to the gradient of the dielectric constant (ε) multiplied by the square of the electric field (E) produced by the electrode. Upon movement of the meniscus, the light from waveguide 216 is switched from waveguide 217 to waveguide 218 and vice-versa.

FIG. 4 is a top plan view of an array 400 of deformable fluid/air interfaces 410 in accordance with the present invention. The array 400 is formed of a substrate 402 having a plurality of apertures 404 formed therein. The apertures 404 may be formed by, but not limited to, laser, mechanical or chemical methods. The fluid/air interfaces 410 can be arranged in an array to provide a matrix of optical switches. For simplicity, the optical waveguides are not shown.

A liquid 406A having a deformable fluid/air interface or meniscus 406B is disposed within the apertures 404. This embodiment is comprised of a stack of silicon and glass plates that have been bonded using anodic bonding techniques. The silicon layers serve as electrodes for an electrohydrodynamic actuator.

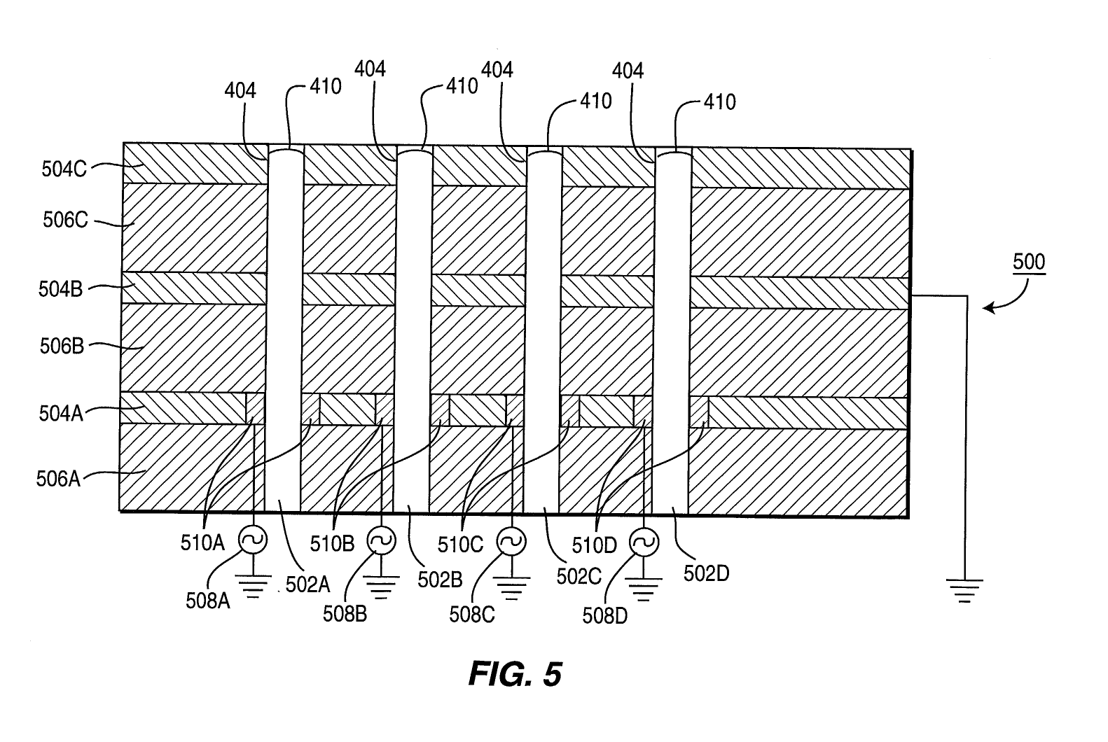

A cross-section of the array 400 of FIG. 4 taken along 5-5 is shown in FIG. 5 illustrating an actuator array 500 for selectively altering the interfaces 410. The electrohydrodynamic actuator array 500 comprises layers of silicon 504A, 504B and 504C interleaved with layers of glass 506A, 506B and 506C. The capillaries 502A, 502B, 502C and 502D that contain the fluid are formed through layers of silicon and glass. The deformable fluid/air interface 410 is formed at the end of each capillary. To form each actuator within the actuator array 500, silicon layer 504B is grounded and an individual ring electrode 510A, 510B, 510C and 510D are formed around each capillary 502A, 502B, 502C and 502D. Each of the ring electrodes 510A, 510B, 510C and 510D are individually addressable to control the interface 410 at the end of each of the capillaries 502A, 502B, 502C and 502D.

Voltage supplies 508A, 508B, 508C, and 508D are coupled to the electrodes 510A, 510B, 510C, and 510D. The voltage supplies 508A, 508B, 508C, and 508D apply a voltage to the electrodes 510A, 510B, 510C, and 510D thus creating an electrohydrodynamic effect within the capillaries 502A, 502B, 502C and 502D. The electrohydrodynamic effect is used to deform the deformable fluid/air interface 410 as previously described and switch an optical signal from one waveguide to another.

It should be noted that by controlling the reflection coefficient of the interface, the present invention will allow selective switching or redirecting of the input optical signals to different output waveguides (not shown). To calculate the intensity of the output signal, a computation is required. A computation example is provided below.

Calculation of the Reflection Coefficient for Differential Refractive Index of the Fluid Media

$$R = \frac{1}{2} \frac{{sin}^{2} ( i - r )}{{sin}^{2} ( i + r )} + \frac{{tan}^{2} ( i - r )}{{tan}^{2} ( i + r )}$$

$$\text{where:}$$

$$\frac{sin r}{sin i} = \frac{{n}_{1}}{{n}_{2}}$$

r=angle of refraction

i=angle of incidence

n1=refractive index incidence media

n2=refractive index refraction media

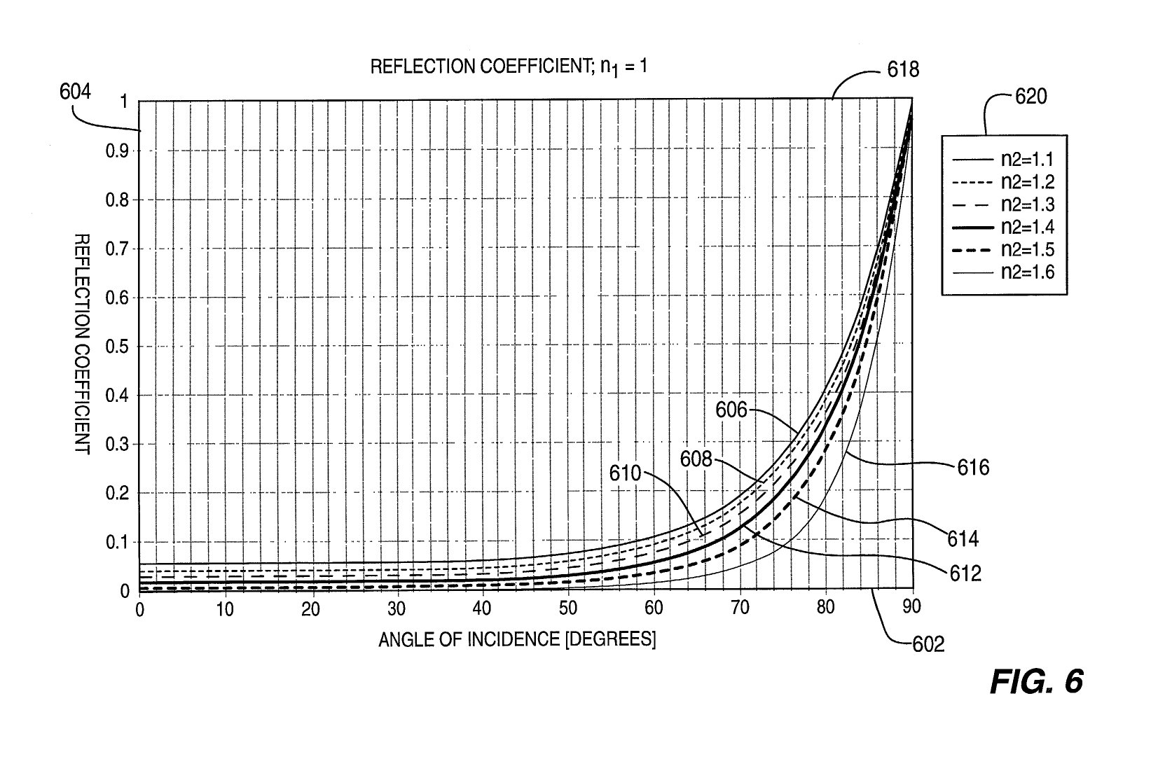

FIG. 6 is a graph of the reflection coefficient as a function of angle of incidence. The lower horizontal legend 602 indicates the angle of incidence and degrees, while the vertical legend 604 located on the left-hand side of the chart indicates the reflective coefficient where n₁=1 (graph 618). Each of the plots 606, 608, 610, 612, 614 and 616 represents a refractive index of the refraction media as seen in the legend 620. The reflection coefficient reaches one, or 100% when the angle of incidence is 90°. This relation holds true for almost all of the n₂ between 1.1 and 1.6. The relation of the reflection coefficient to the angle of incidence parallels from 0° to 50° and 80° and 90° angle of incidence. The reflective coefficient only reaches 0.5 between 80° and 90° of angle of incidence of all n₂. This chart clearly demonstrates the need to maintain an angle of incidence as close to 90° as possible in order to achieve almost any useful reflection coefficient when n₂ is greater than n₁. For the case when n₂ is less than n₁, a reflection coefficient near 100% can be attained when the total internal reflection condition is satisfied, being this the preferred embodiment.

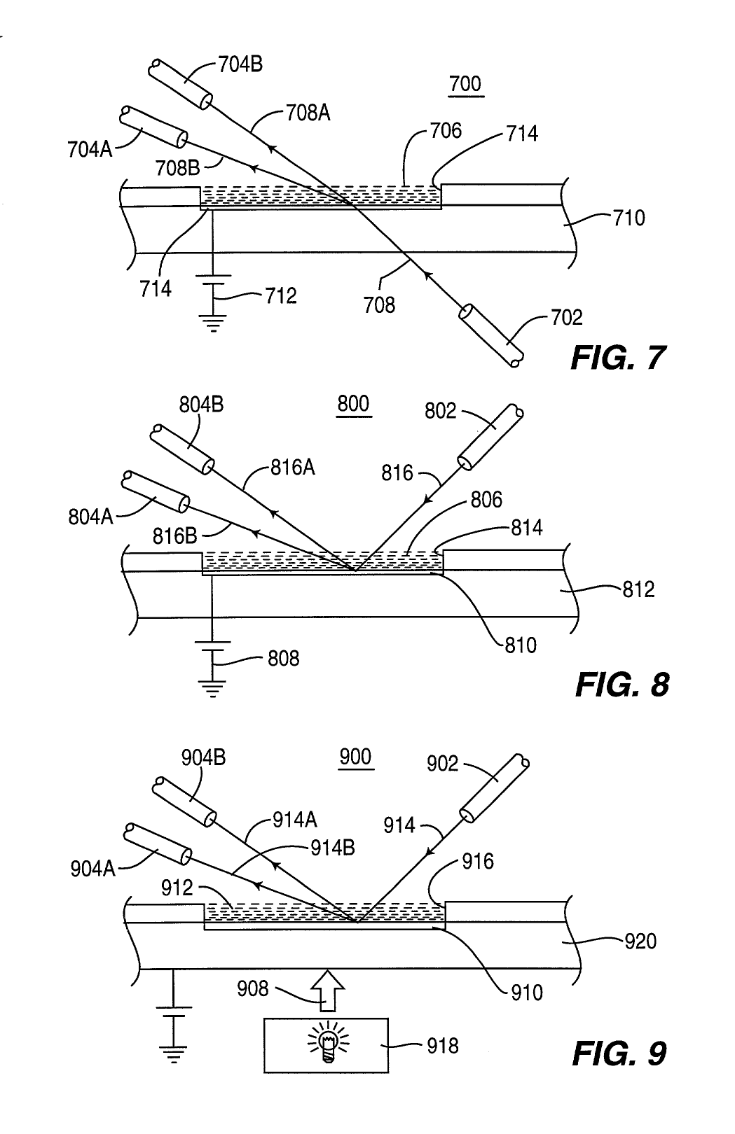

FIG. 7 is a schematic view illustrating another embodiment of an optical switch 700. Optical switch 700 comprises a substrate 710 having a fluid 706 in a reservoir 714. An input waveguide 702 is positioned under the substrate 710 while two output waveguides 704A and 704B are positioned above the substrate 710 and a voltage source 712 is electrically coupled to the substrate 710 via a transparent electrode 714. The substrate 710 is transparent. The fluid 706 in the reservoir 714 has a refractive index gradient that is reconfigurable as voltage is applied to the fluid 706. The voltage source 712 generates a polarization layer of charge in the fluid 706 in a similar manner as in an electrohydrodynamic actuator. As the refractive index gradient of the fluid 706 is changed, light passing through the fluid 706 is bent or refracted. Some examples of fluids having refractive index gradients controllable by a voltage source that may be used by the present invention include, but are not limited to, organic solvents such as DMF, Methanol and hydrocarbons and aqueous based solutions. By transmitting an optical signal 708 through the fluid 706, the refractive index gradient of the fluid 706 may be changed to redirect the output 708A and 708B into a plurality of target output waveguides 704A and 704B.

FIG. 8 is a schematic view illustrating another embodiment of an optical switch 800. Optical switch 800 comprises a substrate 812 having a fluid 806 in a reservoir 814, an input waveguide 802 is positioned above the substrate 812 while two output waveguides 804A and 804B are also positioned above the substrate 812 and a voltage source 808 is electrically coupled to the substrate 812.

As in the previous embodiment, the fluid 806 has a controllable refractive index gradient that may be reconfigured by a voltage source 808. Some examples of fluids having refractive index gradients controllable by a voltage source that may be used by the present invention include, but are not limited to, organic solvents such as DMF, Methanol and hydrocarbons and aqueous based solutions.

The voltage source 808 is electrically coupled to a plate electrode 810 that has been affixed to the substrate 812. The plate electroplate 810 forms the bottom of the fluid reservoir 814. As a voltage is applied or removed from the fluid 806, the refractive index gradient of the fluid 806 changes. An optical signal 816 is transmitted from a input optical waveguide 802 into the fluid 806 to be reflected from the plate electrode 810 into a plurality of optical waveguides 804A or 804B. The controllable refractive index gradient of the fluid 806 allows the reflective optical signal 816 to be reflected into either of the output optical waveguides 804A or 804B. The selection of the waveguide is dependent on whether or not a voltage source 808 is applied to the electrode 810. When a voltage from voltage source 808 is applied or removed, the polarization layer of charge in the controllable refractive index gradient of the fluid 806 changes. The change in the controllable refractive index gradient causes the optical signal to be reflected to either the first output waveguide 804A to a second output waveguide 804B.

FIG. 9 is a schematic view illustrating another embodiment of the optical switch 900. Optical switch 900 comprises a substrate 920 having a fluid 912 in a reservoir 916. An input waveguide 902 is positioned above the substrate 920 while two output waveguides 904A and 904B are also positioned above the substrate 920. Forming the bottom of the reservoir 916 is an optically active interface 910 coupled to a light source 918 projecting an incident light 908 into the optically active interface 910. The substrate 920 is transparent.

When light traveling through the input optical waveguide 902 strikes the optically active interface 910 through the controllable refractive index gradient of the fluid 912, it is reflected to one of two of the optical output waveguides 904A and 904B. The designation of the target waveguide 904A and 904B is controlled through the controllable refractive index gradient of the fluid 912, as the optically active interface 910 is changed by the incident light 908, the controllable refractive index gradient 912 is affected such that it reflects the input light 902 into one of the specific optical output waveguide 904A and 904B. An optically active interface 910 may be, but is not limited to, silicon or some other photo-conductive material. Some examples of fluids having refractive index gradients controllable by an active interface 910 that may be used by the present invention include, but are not limited to, organic solvents such as DMF, Methanol and hydrocarbons and aqueous based solutions.

While this invention has been described with an emphasis upon preferred embodiment, it will be apparent to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed is:

1. A microfluidic optical switch comprising:
a fluid contained in a reservoir having a characteristic;
a first optical waveguide having an end located proximate said fluid;
at least one second optical waveguide having an end located proximate said fluid; and
an actuator coupled to said fluid for changing the characteristic of the fluid.

2. The optical switch of claim 1, wherein said microfluidic actuator comprises an electrohydrodynamic actuator.

3. The optical switch of claim 1, wherein said characteristic is a deformable interface formed on said fluid.

4. The optical switch of claim 1, wherein said fluid further comprises a liquid/liquid interface.

5. The optical switch of claim 3, wherein said actuator controls the shape of the deformable interface.

6. The optical switch of claim 1, wherein said characteristic is a controllable refractive index gradient.

7. The optical switch of claim 1, wherein said fluid further comprises a controllable refractive index gradient region that is controlled by an electric signal.

8. The optical switch of claim 1, wherein said fluid further comprises a controllable refractive index gradient region that is controlled by an incident light.

9. The optical switch of claim 1, wherein said reservoir is a tubule.

10. A method for operating a microfluidic optical switch comprising:
supplying light through a first waveguide to be incident upon a fluid;
altering a characteristic of the fluid; and
directing, in response to the characteristic alteration, the light into a second waveguide.

11. The method of claim 10, wherein said characteristic is a position of a meniscus.

12. The method of claim 10, wherein said characteristic is a refractive index gradient.

13. The method of claim 12, further comprising:
controlling said controllable refractive index gradient using an electric signal.

14. The method of claim 12, further comprising:
controlling said controllable refractive index gradient using an incident light.

15. The method of claim 10, wherein said altering step further comprises:
activating an actuator to alter the characteristic.

16. The method of claim 15, wherein said actuator is an electrohydrodynamic actuator.

17. The method of claim 10, wherein said directing step further comprises:
directing said light into one of a plurality of waveguides.
